(19) United States
(12) Patent Application Publication
(10) Pub. No.: US 2020/0154751 A1
(43) Pub. Date: May 21, 2020

(54) COMPOSITIONS AND METHODS FOR MAKING A CHEWABLE OR GUMMY NUTRITIONAL SUPPLEMENT

(71) Applicant: HILO NUTRITION INC., Columbus, OH (US)

(72) Inventors: Eric Torgerson, Columbus, OH (US); Andrew Sauer, Upper Arlington, OH (US)

(21) Appl. No.: 16/686,662

(22) Filed: Nov. 18, 2019

Related U.S. Application Data
(60) Provisional application No. 62/769,270, filed on Nov. 19, 2018.

(51) Int. Cl. A23L 29/30; A23L 33/00; A23L 33/135; A23L 33/175; A23L 33/29; A23L 29/269; A23L 29/231; A23L 29/281; A23L 29/25; A23L 29/262

(52) U.S. Cl. CPC A23L 29/37; A23L 33/30; A23L 33/135; A23L 33/175; A23L 29/262; A23L 29/272; A23L 29/231; A23L 29/281; A23L 29/25; A23L 33/29

(57) ABSTRACT

A chewable or gummy composition can include a matrix comprising a carbohydrate mixture, the carbohydrate mixture comprising at least two of a non-reducing sugar, a sugar alcohol, or a fiber. The composition further includes one or more active ingredients.

### CROSS-REFERENCE TO RELATED APPLICATIONS

This application claims the priority benefit of U.S. Provisional Patent App. No. 62/769,270 filed Nov. 19, 2018, which is incorporated herein by reference in its entirety.

### TECHNICAL FIELD

Embodiments of the technology relate, in general, to nutritional supplements, and in particular, to compositions and methods for making a chewable or gummy nutritional supplement.

### BACKGROUND

Specialized ingredients are used to promote performance or health benefits, such as energy and focus related to caffeine and muscular endurance from beta-alanine. Nutritional supplements seek to deliver improved exercise performance, strength, endurance, mental benefits (e.g., mental processing speed), and improved sleep as well as other related physical health effects. Specifically, some nutritional supplements are formulated to be taken 15 to 30 minutes prior to a workout or an athletic activity to deliver acute benefits.

Nutritional supplements, especially pre-workout supplements, are often available in pill form, powder form, which must be mixed before use, or pre-mixed liquids packaged in ready-to-drink containers. Liquid supplements are preferably consumed cold, which creates inconveniences (e.g., planning time). Some ingredients take significant time to achieve full hydration, such as branch chain amino acids, leucine, isoleucine, and valine, which increases the time needed to properly prepare the supplement. In addition, some performance ingredients are unstable in water (e.g., creatine breaks down to creatinine over time). A need exists for improved nutritional supplements that are easy to use and that reduce the time and energy needed to consume the supplement.

### BRIEF DESCRIPTION OF THE DRAWING

The present disclosure will be more readily understood from a detailed description of some example embodiments taken in conjunction with the following FIGURES:

FIG. 1 depicts a schematic flow chart illustrating a method of making a chewable or gummy nutritional supplement according to an embodiment.

### SUMMARY

A chewable or gummy composition can include a matrix comprising a carbohydrate mixture, the carbohydrate mixture comprising at least two of a non-reducing sugar, a sugar alcohol, or a fiber. The composition further includes one or more active ingredients.

A method of making a composition includes blending the non-reducing sugar, the hydrocolloid gelling ingredient, the gum to form a first mixture and heating the first mixture in a vessel heated to 85° C. The method further includes blending the sugar alcohol, the fiber, additional non-reducing sugar, the one or more active ingredients, and optional sweeteners, flavoring, or coloring to form a second mixture and combining the first and second mixtures in the vessel to form a third mixture. The method also includes blending beta-alanine, water, malic acid, and citric acid to form a fourth mixture and combining the third and fourth mixtures in the vessel to form a fifth mixture.

### DETAILED DESCRIPTION

Various non-limiting embodiments of the present disclosure will now be described to provide an overall understanding of the principles of the structure, function, and use of the compositions and methods for making chewable or gummy nutritional supplement disclosed herein. One or more examples of these non-limiting embodiments are illustrated in the accompanying drawing. Those of ordinary skill in the art will understand that systems and methods specifically described herein and illustrated in the accompanying drawing are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the compositions and methods described herein. None of the features or components shown in the drawings or discussed below should be taken as mandatory for any specific implementation of any of the apparatuses, devices, systems or methods unless specifically designated as mandatory. For ease of reading and clarity, certain components or methods may be described solely in connection with a specific FIGURE. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Described herein are example embodiments of compositions and methods for making a chewable or gummy nutritional supplement. In one example embodiment, a chewable or gummy composition includes a chewable or gummy matrix and active ingredients. A chewable or gummy nutritional supplement can be taken without any prior preparation, such as rehydrating a powder in water. Taking a chewable or gummy nutritional supplement also reduces the “sloshy” feeling associated with drinking a nutritional supplement, or taking a number of supplement pills, prior to working out or engaging in another physical activity. Liquid supplements are often gritty due to the insoluble nature of many performance ingredients, which is avoided when the supplement is in a chewable or gummy form. Additionally, chewable or gummy supplements may be more approachable for consumers versus a significant number of pills, which are often taken with water. Additives that are included in powder or pre-mixed supplements to improve the solubility can be avoided in a chewable or gummy form. Thus, a chewable or gummy nutritional supplement requires fewer tools (e.g., water bottle), time, and steps required to take a powder or pre-mixed supplement. Improving the ease of use of a nutritional supplement increases the likelihood that a user will incorporate the supplement into their routine. Moreover, the small size of chewable or gummy nutritional supplements compared to ready-to-drink options reduces shipping costs and related environmental impact.

A chewable or gummy composition according to an example embodiment is described below. The composition is a semi-solid product that, unlike a pill, can be chewed before swallowing. The chewable or gummy composition has a low enough water content such that it remains semi-solid at room temperature. Water content of the final composition may be in a range of 1 wt % to 25 wt %. As mentioned above, the composition comprises a chewable or gummy matrix and one or more active ingredients. The weight of the chewable or gummy composition may vary, as well as the total weight of a recommended serving of the chewable or gummy composition. In various embodiments, the weight of the chewable or gummy composition may be in a range of, for example, 2 g to 15 g, 2 g to 10 g, 2 g to 6 g. The total weight of a recommended serving of the chewable or gummy composition may be, in some embodiments, in a range of 4 g to 100 g, 4 g to 50 g, 25 g to 35 g, or 28 g to 32 g. The number of chewable or gummy composition per recommended serving may also vary. For example, the recommended serving may include 1 to 8 chewable or gummy compositions.

The matrix comprises a carbohydrate mixture of a non-reducing sugar and at least one of a sugar alcohol and a fiber. The non-reducing sugar may be a monosaccharide or disaccharide. Examples of the non-reducing sugar include, without limitation, trehalose, sucrose, raffinose, stachyose, verbascose, and combinations thereof. The non-reducing sugar may be determined based on the ability of the sugar to remain a non-reducing sugar after the processing steps (e.g., not be converted into glucose due to heat and/or the presence of acid). For example, sucrose may be excluded where relatively high heat or acid is used. Examples of the sugar alcohol include, without limitation, polyglycitol, isomaltitol, lactitol, maltitol, and combinations thereof. The sugar alcohol should not have a tendency to crystallize under the processing conditions discussed below or usual storage conditions (e.g., room temperature). Examples of the fiber include, without limitation, fructooligosaccharides (FOS), other soluble dietary fiber syrups, such as chicory root fiber syrup or tapioca syrup, and combinations thereof. In typical gummy products, a monosaccharide or disaccharide sugar can make up to 85% of the finished product. Including one or both of the sugar alcohol and fiber reduces the amount of sugar and calories per gram, while not adversely affected the taste and texture. The amount of carbohydrate mixture in the chewable or gummy composition may be in a range of, for example, 60 wt % to 85 wt %. Table 1 shows various example formulations of the carbohydrate mixture.

TABLE 1

| | | Option | Option | Option | Option |
|---|---|---|---|---|---|
| Ingredient | Example | A | B | C | D |
| Non-reducing Sugar | Trehalose | 50% | 45% | 35% | 55% |
| Sugar Alcohol | Polyglycitol | 25% | 55% | 65% | 0% |
| Fiber | FOS | 25% | 0% | 0% | 45% |

wt % of total carbohydrate

The non-reducing sugar may be present in the chewable or gummy composition in a range of, for example, 30 wt % to 45 wt % or 30 wt % to 35 wt %. The sugar alcohol and/or fiber may be present in the chewable or gummy composition in a range of, for example, 30 wt % to 45 wt % or 30 wt % to 35 wt %.

In an embodiment, the matrix also includes a hydrocolloid gelling ingredient that increases the solidity of the matrix. Examples of the hydrocolloid gelling ingredient include, without limitation, alginate, pectin, carrageenan, gellan gum, gelatin, agar, modified starch, methyl cellulose, hydroxypropylmethyl cellulose, and combinations thereof. Determining which hydrocolloid gelling ingredient is used may be based on the desired active ingredients or dietary considerations. Gelatin, for example, cannot generally be used if intending to create a kosher composition. The chewable or gummy composition may include the hydrocolloid gelling ingredient in a range of greater than 0 wt % to 5 wt %, or 2 wt %. In an embodiment, the matrix optionally includes one or more gums. A gum prevents the composition from becoming rock solid by holding water within the matrix. Examples of the gum include, without limitation, locust bean gum, guar gum, xanthan gum, and combinations thereof. The chewable or gummy composition may include the gum in a range of greater than 0% to 0.5%. The chewable or gummy texture of the matrix is determined in large part by the ratio of gelling ingredient and gum ingredient.

The active ingredients in the chewable or gummy composition may vary based on the desired effect (e.g., energy, endurance, etc.). Examples of the active ingredients include, without limitation, vitamins, minerals, antioxidants, amino acids, probiotics, stimulants, nitrates, phospholipids, hormones, botanicals, such as plant extracts, any metabolites thereof, or any combination thereof. Specific active ingredients include, without limitation, betaine, beta-alanine, caffeine, leucine, isoleucine, valine, lutein, choline, creatine, epicatechin, melatonin, phosphatidylserine, green tea extract, beet root extract (plant extract), potassium nitrate, and beta-hydroxy-beta-methylbutyrate (HMB). The chewable or gummy composition may include the active ingredient(s) in a range of greater than 0 wt % to 15 wt %. The weight percentage of the active ingredients is determined at least in part by the desired dosage or payload (e.g., gram per serving). The active ingredients may be embedded in and/or encased by the chewable or gummy matrix. When encased, the matrix acts as a shell with a liquid-filled center. Embedding and encasing the active ingredients may increase the total payload of active ingredient per total weight of the composition.

The chewable or gummy composition may include additional ingredients, such as sweeteners (e.g., acesulfame potassium), flavoring ingredients, and/or coloring ingredients. The sweetener may also be a high-potency (e.g., stevia, sucralose, monkfruit). Although the sweetener may be a non-reducing sugar, it is not present in a high enough amount that affects the reaction that creates the structure of the matrix. For example, the chewable or gummy composition may include the sweetener in a range of 0.01 wt % to 0.1 wt % or at 0.05 wt %. The flavoring ingredients may include, without limitation, acids such as citric acid and malic acid.

As described above, the composition includes a non-reducing sugar. The combination of a reducing sugar and some active ingredients impairs the long-term viability of the composition. For example, the combination of a reducing sugar and beta-alanine creates a reaction that causes the chewable or gummy matrix to brown, harden, and change taste—effects that worsen over time. This occurs due to the Maillard reaction between amino acids and the reducing sugar. More specifically, the reactive carbonyl group of the reducing sugar reacts with the nucleophilic amino group of the amino acid and ultimately results in aroma, color, and flavor compounds. In many cases with food, the reaction is desired to achieve certain characteristics. However, in the case of a chewable or gummy composition, it produces a brown color and off-taste for fruit and sugar flavors. The reaction is enhanced under higher temperatures and within an alkaline environment.

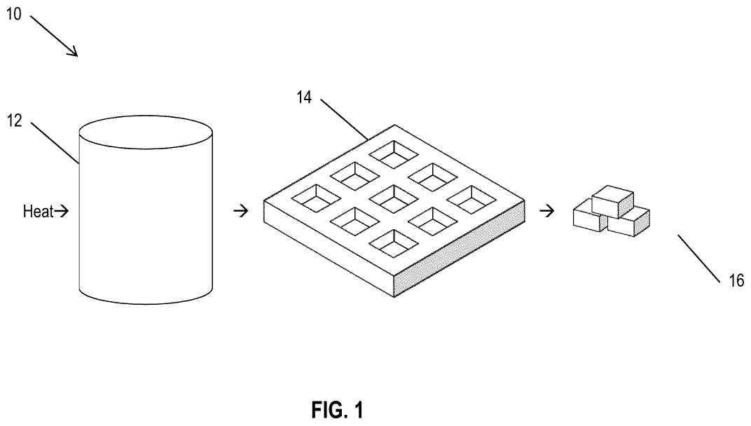

A method 10 for making a chewable or gummy composition according to an example embodiment is described below. The blending of ingredients may be done in more than one step. In such an embodiment, ingredients that take more hydration time to become homogeneous (e.g., a protein) may be added together towards the beginning of the process. Further, having multiple blending steps may improve the resulting homogeneity of a mixture of liquids, powders, and syrups. In an embodiment, water, the non-reducing sugar, the hydrocolloid gelling ingredient, the gum, and caffeine are first blended together in a vessel 12, as shown in FIG. 1. This first mixture is heated to a minimum of 85° C. This serves several purposes. Pre-blending the ingredients increases homogeneity and solubility. For example, the gum, such as locust bean gum, should be heated for full solubility and, without homogeneity, would thicken inconsistently. Caffeine is added at this earliest stage to maximize solubility time. The heat also activates the hydrocolloids (i.e., the gelling ingredient and gum) to begin the thickening process. The heat disperses the gel and allows it to form a three-dimensional network with solvent (i.e., the water) in the spaces. Specific to agar and gelatin, they are cold-set, in which the ingredients are dissolved in hot water and form a stabilized network upon cooling. Finally, the heat, through pasteurization, reduces the microbiological bioburden (e.g., bacteria) to a point at which the food is safe. At the end of the process, there is limited water activity for microbiological organisms to grow. This first mixture may be maintained at a temperature of at least 85° C. for a period of seconds to a few minutes, after which the temperature may be reduced to be in a range of 50° C. to 85° C. to reduce or prevent boiling.

Next, the sugar alcohol and fiber are blended together. Additional ingredients may also be included, such as additional non-reducing sugar, additional active ingredients, and any optional sweeteners, flavoring, and coloring. Once blended, these ingredients are added to the heated vessel containing the first mixture. This second mixture is heated to at least 85° C. for a period of seconds or a few minutes before being cooled to a temperature in a range of 50° C. to 85° C.

Next, beta-alanine, water, acid (e.g., malic acid, citric acid) are blended to reduce the potential of the beta-alanine to be involved in the Mallard browning reaction. This blended mixture is added to the mixture in the heated vessel 12. The mixtures described above may be stirred to increase the speed at which homogeneity is reached and/or to prevent localized overheating/cooling.

The resulting mixture is poured into shaped molds 14, shown in FIG. 1, that control the shape and weight of the final product. The molds 14 can be, for example, square or another suitable shape for a gummy. The mold 14 may be made of, for example, metal, plastic, or starch. The molds 14 and product are cooled to solidify the chewable or gummy compositions. In an embodiment, a coating may be added to the mold and/or gummy before or after cooling. For example, the coating may be a sugar coating or an oil coating. The product 16 is ejected onto drying racks and evaporated (e.g., at 37° C.) a period of a few hours to several days to lower the water content further. The time of evaporation is influenced by the final moisture desired, the capability of the manufacturing system, and the size and shape of gummy. The water activity in the final chewable or gummy nutritional supplement is used to control texture and the growth of bacteria, yeast, and molds.

The following examples are provided to help illustrate embodiments of the present disclosure and are not comprehensive or limiting in any manner.

### Example 1

In an embodiment, the composition includes the ingredients listed in Table 2.

TABLE 2

| Ingredient | Weight % | g/serving |
|---|---|---|
| Trehalose | 34% | 10.2 |
| Polyglycitol Syrup | 16% | 4.8 |
| FOS | 15% | 4.5 |
| Acids | 5% | 1.5 |
| Water | 16% | 4.8 |
| Active (Beta-Alanine, Betaine, Caffeine) | 9.8% | 2.94 |
| Flavor, Sweeteners, Colors | 2% | 0.6 |
| Agar | 2% | 0.6 |
| Gum | 0.2% | 0.06 |
| Total | 100% | 30 |

The active ingredients are betaine, beta-alanine, and caffeine and are limited to 9.8%, or about 10%, of the total weight of the final composition. This formulation delivers 150 mg caffeine, 1 g betaine, and 1.6 g beta-alanine per serving. The total weight of a serving is no less than 28 g to 30 g. Using this formulation, a recommended serving could comprise, for example, eight chewable or gummy nutritional supplements, each comprising 3.75 g. The nutritional facts generated from this example product are shown in Table 3.

TABLE 3
Serving Size 8 Gummies

| Amount per 8 Gummies | | % DV |
|---|---|---|
| Calories | 70 | |

| | | | |
|---|---|---|---|
| Total Carbohydrate | 18 | g | 6% |
| Dietary Fiber | 4 | g | 15% |
| Total Sugars | 8 | g | |
| Includes 8 g Added Sugars | | | 17% |
| Sugar Alcohol | 5 | g | |
| Beta-Alanine | 1.6 | g | |
| Betaine (Trimethylglycine) | 1 | g | |
| Caffeine | 150 | mg | |

As described above, a benefit of the use of dietary fibers and sugar alcohols is a reduction in overall sugar and calories per serving. This reduction is about 1 calorie per gram in this example.

### Example 2

In an embodiment, a chewable or gummy composition for improving strength includes a matrix comprising trehalose, chicory root fiber, polyglycitol, locust bean gum, and agar. The active ingredients comprise calcium beta-hydroxy-beta-methlybutyrate (HMB), vitamin D, and a probiotic. The composition also includes flavoring and sucralose.

### Example 3

In an embodiment, a chewable or gummy composition for improving cognition includes a matrix comprising raffinose, FOS, maltitol, carrageenan, and guar gum. The active ingredients comprise citicholine, green tea extract, and phosphatidylserine (phospholipid). The composition also includes flavoring.

### Example 4

In an embodiment, a chewable or gummy composition for improving strength includes a matrix comprising stachyose, FOS, polyglycitol, and pectin, and gellan gum. The active ingredients comprise beet root extract (plant extract), potassium nitrate. The composition also includes flavoring.

### Example 5

In an embodiment, a composition for improving energy includes a liquid-filled chewable or gummy nutritional supplement. The composition includes a shell comprising flavors and a matrix of trehalose, chicory root fiber, polyglycitol, locust bean gum, and agar. The active ingredients comprise caffeine, lutein, and zeaxanthin. The caffeine may be embedded in the matrix, and the lutein and zeaxanthin may be in liquid form encased by the shell. The inner liquid may also include flavoring.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the disclosure to be defined by the claims appended hereto.

What is claimed is:

1. A chewable or gummy composition comprising:
a matrix comprising a carbohydrate mixture, the carbohydrate mixture comprising at least two of a non-reducing sugar, a sugar alcohol, or a fiber; and
one or more active ingredients.

2. The composition of claim 1, wherein the carbohydrate mixture comprises the non-reducing sugar and the sugar alcohol.

3. The composition of claim 1, wherein the carbohydrate mixture comprises the non-reducing sugar and the fiber.

4. The composition of claim 1, wherein the carbohydrate mixture comprises the non-reducing sugar, the sugar alcohol, and the fiber.

5. The composition of claim 1, wherein the composition comprises the carbohydrate mixture in a range of greater than 60 wt % to 85 wt % and the one or more active ingredients in a range of greater than 0 wt % to 15 wt %.

6. The composition of claim 1, wherein the non-reducing sugar is selected from the group consisting of trehalose, sucrose, raffinose, stachyose, verbascose, and a combination thereof.

7. The composition of claim 1, wherein the carbohydrate mixture comprises the non-reducing sugar in a range of 35 wt % to 55 wt %.

8. The composition of claim 1, wherein the sugar alcohol is selected from the group consisting of polyglycitol, isomaltitol, lactitol, maltitol, and a combination thereof.

9. The composition of claim 1, wherein the carbohydrate mixture comprises the sugar alcohol in a range of greater than 0 wt % to 55 wt %.

10. The composition of claim 1, wherein the fiber is selected from the group consisting of fructooligosaccharides (FOS), chicory root fiber, tapioca fiber, and a combination thereof.

11. The composition of claim 1, wherein the carbohydrate mixture comprises the fiber in a range of greater than 0 wt % to 45 wt %.

12. The composition of claim 1, wherein the one or more active ingredients are selected from the group consisting of a vitamin, a mineral, an antioxidant, an amino acid, a probiotic, a stimulant, a nitrate, a phospholipid, a hormone, a botanical, a metabolite thereof, and a combination thereof.

13. The composition of claim 1, wherein the matrix comprises at least one of a hydrocolloid gelling ingredient or a gum.

14. The composition of claim 13, wherein the hydrocolloid gelling ingredient is selected from the group consisting of alginate, pectin, carrageenan, gellan, gelatin, agar, a modified starch, methyl cellulose, hydroxypropylmethyl cellulose, and a combination thereof.

15. The composition of claim 13, wherein the composition comprises the hydrocolloid gelling ingredient in a range of greater than 0 wt % to 5 wt % or the gum in a range of greater than 0 wt % to 0.5 wt %.

16. The composition of claim 13, wherein the gum is selected from the group consisting of locust bean gum, guar gum, xanthan gum, and a combination thereof.

17. The composition of claim 1, further comprising water in a range of 1 wt % to 25 wt %.

18. The composition of claim 1, further comprising one or more sweetener, flavoring, coloring, or a combination thereof.

19. A method of making the one or more of the chewable or gummy compositions of claim 1, the method comprising:
blending the non-reducing sugar, the hydrocolloid gelling ingredient, and the gum to form a first mixture;
heating the first mixture to a first temperature of 85° C. or greater;
blending the sugar alcohol, the fiber, the optional additional non-reducing sugar, the one or more active ingredients, and optional sweeteners, flavoring, or coloring to form a second mixture;
combining the first and second mixtures to form a third mixture;
heating the third mixture to a second temperature of 85° C. or greater;
blending beta-alanine, water, malic acid, and citric acid to form a fourth mixture;
combining the third and fourth mixtures to form a fifth mixture;
pouring the fifth mixture into one or more molds; and
cooling the fifth mixture solidify the fifth mixture into the one or more of the chewable or gummy compositions.

20. The method of claim 19, further comprising at least one of:
after heating the first mixture to the first temperature, maintaining the second mixture at a second temperature in a range of 50° C. to 85° C.; or
after heating the first mixture to the first temperature, maintaining the third mixture at a third temperature in a range of 50° C. to 85° C.
